(19) United States
(12) Patent Application Publication
(10) Pub. No.: US 2001/0036302 A1
(43) Pub. Date: Nov. 1, 2001

(54) Method and apparatus for cross modality image registration

(76) Inventor: Michael I. Miller, Jackson, NH (US)

Correspondence Address: Finnegan, Henderson, Farabow, Garrett & Dunner, L.L.P., 1300 I Street, N.W., Washington, DC, 20005-3315, US

(21) Appl. No.: 09/733,055

(22) Filed: Dec. 11, 2000

Related U.S. Application Data
(60) Provisional application No. 60/169,990, filed on Dec. 10, 1999.

(51) Int. Cl. G06K 9/00; G06K 9/68; G06K 9/32; G06K 9/64

(52) U.S. Cl. 382/128; 382/218; 382/294; 382/278

(57) ABSTRACT

An apparatus and method for image registration involves selecting a registration model, selecting a distance measure incorporating the registration model, and registering a first image with a second image using a registration transform using the distance measure.

### RELATED APPLICATION

This patent application claims priority to U.S. Provisional Patent Application No. 60/169,990 filed Dec. 10, 1999, entitled Method and Apparatus for Atlas and Cross Modality Fusion, which is herein incorporated by reference in its entirety.

### BACKGROUND OF THE INVENTION

The present invention relates to image processing systems and methods, and more particularly to image registration systems that combine two or more images into a composite image.

Image registration involves combining two or more images, or selected points from the images, to produce a composite image containing data from each of the registered images. During registration, a transformation is computed that maps related points among the combined images so that points defining related structure in each of the combined images are correlated in the composite image.

Practitioners generally follow two different registration techniques. In the first approach, an individual with expertise in the structure of the object represented in the images labels a set of landmarks in the images that are to be registered. For example, when registering two MRI images of different axial slices of a human head, a physician may label points, or a contour surrounding these points, corresponding to the cerebellum in two images. The two images are then registered by relying on a known relationship among the landmarks in the two brain images.

The mathematics underlying this registration process is known as small deformation multi-target registration. In the previous example of two brain images being registered, using an operator-driven approach, a set of N landmarks identified by the physician, represented by xᵢ, where i=1 . . . N, are defined within the two brain coordinate systems. A mapping relationship, mapping the N points selected in one image to the corresponding N points in the other image, is defined by the equation u(xₗ)=kₗ, where I=1 . . . N. Each of the coefficients, kₗ, is assumed known.

The mapping relationship u(x) is extended from the set of N landmark points to the continuum using a linear quadratic form regularization optimization of the equation:

$$u = arg {min}_{u} \int {‖ Lu ‖}^{2} \qquad ( 1 )$$

subject to the boundary constraints u(xₗ)=kₚ. The operator L is a linear differential operator. This linear optimization problem has a closed form solution. Selecting L=α∇²+β∇(∇·) gives rise to small deformation elasticity. See S. Timoshenko, Theory of Elasticity, McGraw-Hill, 1934 and R. L. Bisplinghoff, J. W. Marr, and T. H. H. Pian, Statistics of Deformable Solids, Dover Publications, Inc., 1965. Selecting L=∇² gives rise to a membrane or Laplacian model. See e.g., Amit, U. Grenander, and M. Piccioni, “Structural image restoration through deformable templates,” J. American Statistical Association. 86(414):376-387, June 1991, and R. Szeliski, Bayesian Modeling of Uncertainty in Low-Level Vision, Kluwer Academic Publisher, Boston, 1989 (also describing a bi-harmonic approach). Selecting L=∇⁴ gives a spline or biharmonic registration method. See Grace Wahba, “Spline Modelsfor Observational Data,” Regional Conference Series in Applied Mathematics. SIAM, 1990, and F. L. Bookstein, The Measurement of Biological Shape and Shape Change, volume 24, Springer-Verlag: Lecture Notes in Biomathematics, New York, 1978.

Another technique for image registration uses the mathematics of small deformation multi-target registration and is image data driven. Here, volume based imagery is generated of the two targets from which a coordinate system transformation is constructed. Using this approach, a distance measure, represented by the expression D(u), represents the distance between a template T(x) and a target image S(x). The optimization equation guiding the registration of the two images using a distance measure is:

$$u = arg {min}_{u} \int {‖ Lu ‖}^{2} + D ( u ) \qquad ( 2 )$$

The distance measure D(u) measuring the disparity between images that are being registered has various forms, e.g., the Gaussian squared error distance ∫|T(h(x))−S(x)|²dx, a correlation distance, or a Kullback-Liebler distance. Registration of the two images involves finding a mapping that reduces this distance.

In the first approach to image registration, registration accuracy depends on the number and location of landmarks selected. Selecting too few landmarks may result in an inaccurate registration. Selecting too many landmarks does not necessarily guarantee accurate registration, but it does increase computations needed for registration. Furthermore, it is not always possible to identify appropriate structural landmarks in all images.

The second technique has computational complexities presented by the number of data points in most images. The second technique can produce local minima that confuse proper registration. This is because when registering two images according to the second technique, if there are many possible orientations of the images produce subregions in the images that are properly matched, the images as a whole can be improperly registered.

Moreover, both techniques may not be desireable when used to register reference information, e.g., anatomic atlas information, with scanned images and when used to register images acquired using different modalities, e.g., registering images acquired with different sensors such as registering MRI image data with CT image data. Many conventional image registration techniques' assume that the image intensities of corresponding image elements (e.g., pixels, voxels, etc.) are identical in the images to be registered. When registering images of different modalities, this assumption is not necessarily true.

There is, therefore, a need for a different registration technique.

### SUMMARY OF THE INVENTION

The present invention provides an apparatus and method for image registration comprising selecting a reference information structure, selecting a sensor model, and matching image data to the reference information structure using the sensor model. Another embodiment consistent with the present invention registers images by selecting a first and a second image, selecting a distribution model corresponding to a segmentation of the first image, and matching the first image and the second image using the selected distribution models. Yet another embodiment consistent with the present invention registers images by selecting a registration model, selecting a distance measure incorporating the registration model, and registering a first image with a second image using a registration transform using the distance measure.

Additional features and advantages of the invention will be set forth in the description which follows, and in part, will be apparent from the description, or may be learned by practicing the invention. The objectives and other advantages of the invention will be realized and obtained by the method and apparatus particularly pointed out in the written description and the claims hereof as well as in the appended drawings.

Both the foregoing general description and the following detailed description are exemplary and explanatory and are intended to provide further explanation of the invention as claimed.

### DESCRIPTION OF THE FIGURES

The accompanying drawings provide a further understanding of the invention. They illustrate embodiments of the invention and, together with the description, explain the principles of the invention.

FIG. 1 is a flow diagram of a method for registering images consistent with the present invention;

FIG. 2 is a diagram of images of an axial section of a human head with 0-dimensional manifolds;

FIG. 3 is a block diagram of an apparatus consistent with the present invention;

FIG. 4 is a flow diagram flow diagram of a method for registering images consistent with the present invention;

FIG. 5 shows an image of a section of a brain with 1-dimensional manifolds;

FIG. 6 shows an image of a section of a brain with a 2-dimensional manifold; and

FIG. 7 shows an image of a section of a brain with a 3-dimensional manifold.

### DETAILED DESCRIPTION OF THE INVENTION

A method and apparatus is disclosed for registering images. Reference will now be made in detail to embodiments consistent with the present invention, examples of which are illustrated in the accompanying drawings.

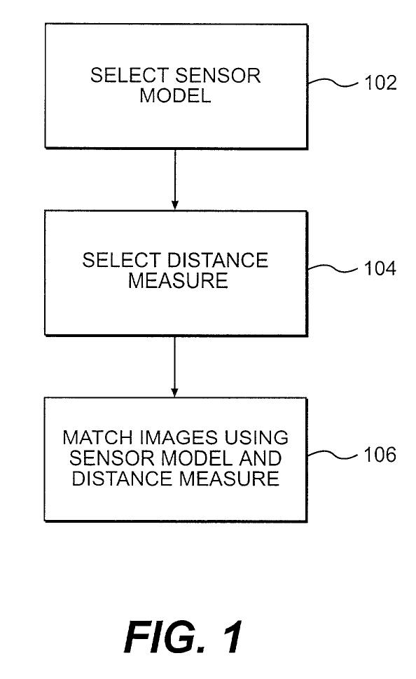

A method for image registration consistent with the present invention comprises selecting a reference information structure, selecting a sensor model, and matching image data to the reference information structure using the sensor model. FIG. 1 is a flow diagram of a method for registering images consistent with the present invention. In this example, a reference information structure, for example, anatomical information stored as an atlas, is registered with scanned imagery. Other examples of reference information structures include databases, electronic documents (e.g., medical journal articles), and maps of relevant structures (e.g., maps of blood vessels). An atlas can contain information in many forms representative of anatomical regions of interest for a particular application. For example, an atlas consistent with the present invention, is a data set of one or more points, curves, surfaces, or subvolumes representing at least one anatomical region of interest. An example of a suitable atlas for this purpose is the Visual Human atlas available from the National Library of Medicine. Scanned imagery used in this embodiment includes, for example, MR, CT, cryosection, or utltrasound images.

In accordance with the method of FIG. 1, one or more sensor models are selected correlating the points, curves, surfaces, or subvolumes in the atlas to corresponding structure in scanned imagery (step 102). The parameters of the models relate to the sensor modality used to acquire the images that are registered. Accordingly, the registration process can be tuned for different sensor modalities. Moreover, registration maps reference structure information into the coordinate frame corresponding to the scanned images being registered.

A registration method consistent with the present invention matches elements of the atlas data set with corresponding elements in the scanned image. A distance measure is selected to provide a quantitative measure indicating how well the atlas and image elements are registered (step 104). For example, a registration process that produces a small distance between corresponding atlas and target image elements is generally a more accurate registration than one that results in a large distance. One example of a suitable distance measure for this method is the Kullback-Liebler distance. Those skilled in the art will recognize that other distance measures are also suitable, such as the L1 absolute value error measure and the L2 squared error measure. In accordance with an embodiment of the present invention, this distance is constructed to relate the models selected in step 102 to the target images. Thus, a distance measure is created that incorporates information about the modalities of image being registered, which in turn incorporates modality information into the image registration process.

Using the distance measure of step 104, a registration transform is computed matching the atlas information and scanned image using the model selected in step 102, which reduces the distance measure (step 106). Registration transformations suitable for this matching operation are disclosed in, for example, U.S. Pat. No. 6,009,212, entitled Method and Apparatus for Image Registration and in U.S. patent application Ser. No. 09/186,359, entitled Rapid Convolution Based Large Deformation Image Matching Via Landmark and Volume Imagery, each of which is incorporated by reference in its entirety. The registration of step 106 not only creates a transform mapping the atlas information to the target image, the transform also maps the scanned image information back into the atlas coordinate system.

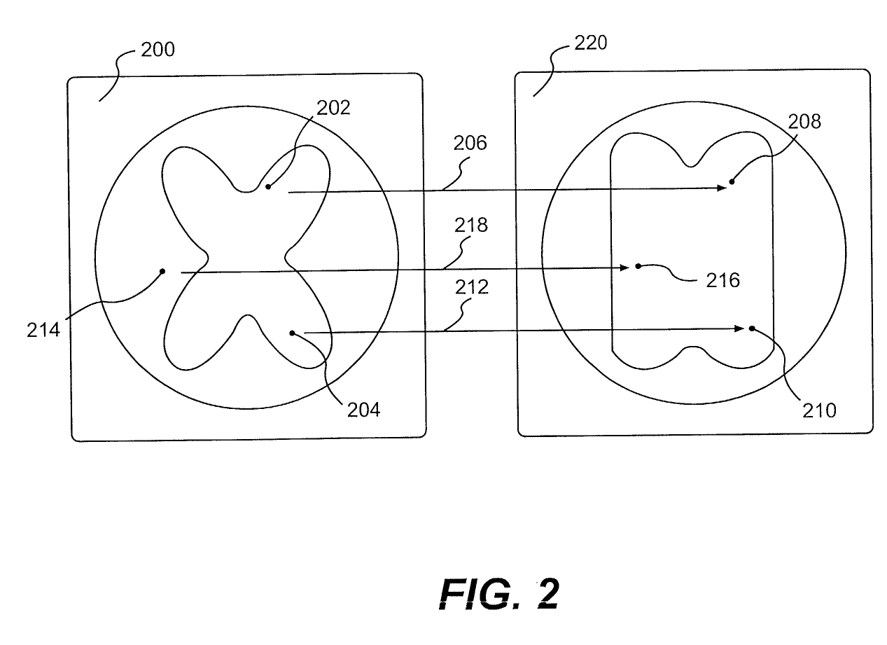

To illustrate principles of this invention, FIG. 2 shows two axial views of a human head. In this example, atlas image 200 contains points 202, 204, and 214 identifying structural points (0-dimensional landmark manifolds) of interest in the image. Image 220 contains points 208, 210, 216, corresponding respectively to image points 202, 204, 214, via vectors 206, 212, 218, respectively. The registration process matches the atlas image with the scanned image using, for example, the corresponding landmarks in each image.

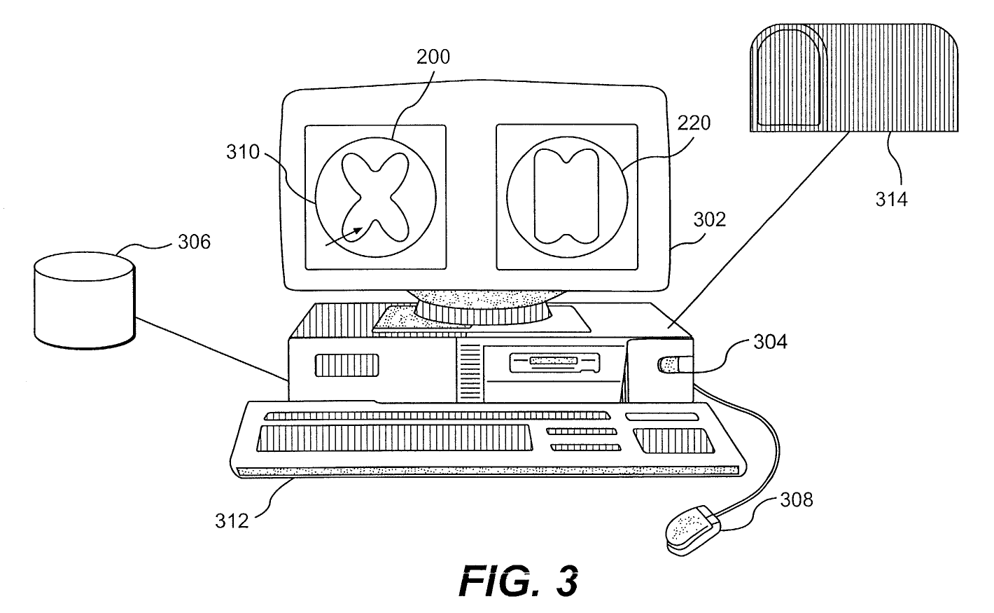

FIG. 3 is a block diagram of an apparatus consistent with the present invention for image registration. Apparatus consistent with the present invention can be constructed from electronic hardware components or software or a combination thereof. Suitable structure for implementing the methods disclosed herein includes, but is not limited to, computer workstations, imaging devices, medical devices including surgical navigation systems (see e.g., U.S. Pat. No. 5,383,454, incorporated herein by reference), and distributed networks of computers.

A medical imaging scanner 314 obtains images using such sensor modalities as MRI, CT, Ultrasound, PET, etc., and stores them on a computer memory 306 which is connected to a computer central processing unit (CPU) 304. Reference image structures, such as atlases, can also be stored in computer memory 306. One of ordinary skill in the art will recognize that a parallel computer platform having multiple CPUs is also a suitable hardware platform for the present invention, including, but not limited to, parallel machines and workstations with multiple processors. Computer memory 306 can be directly connected to CPU 304, or this memory can be remotely connected appropriately, such as through a communications network.

If an operator chooses to use landmarks to register the images, the operator, using pointing device 308, moves cursor 310 to select points 202, 204, 214 in FIG. 2, which are then displayed on a computer monitor 302 along with images 200, 220. Selected image points 202, 204, and 214 are 0-dimensional manifold landmarks. Once the operator selects manifold landmark points 202, 204, and 214 in image 200, the operator identifies the corresponding image points 208, 210, 216.

In addition, the operator may select a region of interest in the image. Focusing the computation on a relatively small region of interest reduces both computation and storage requirements because transformation is computed over a subregion of interest. It is also possible that in some applications, the larger image is the desired region of interest. In other applications, there may be default regions of interest that are automatically identified.

The operator also selects an appropriate sensor model that represents how the atlas image information (e.g., point, curves, surfaces, or subvolumes) would appear at corresponding locations in the scanned image. The models can be, for example, selected from a menu of models presented on computer monitor 302 using pointing device 308. Also, for example, parameters for models can be keyed in using keyboard 312. For example, when a Gaussian model is appropriate, the operator keys in values for a mean and variance for the Gaussian distribution.

The operator can select an equation for the distance measure several ways including, but not limited to, selecting an equation from a list using pointing device 308, entering into CPU 304 an equation using keyboard 312, or reading a default equation from memory 306. Although several of the registration steps are described as selections made by an operator, implementation of the present invention is not limited to manual selection. For example, the information can be defaults read from memory or determined automatically.

After the registration information has been provided by the operator or otherwise determined, CPU 304 registers the reference information structure (atlas image) with the scanned image using all or a subset of the information described above. Those skilled in the art will recognize that the structure described above in apparatus of FIG. 3 can also be programmed to execute the steps of the registration methods consistent with the present invention described below.

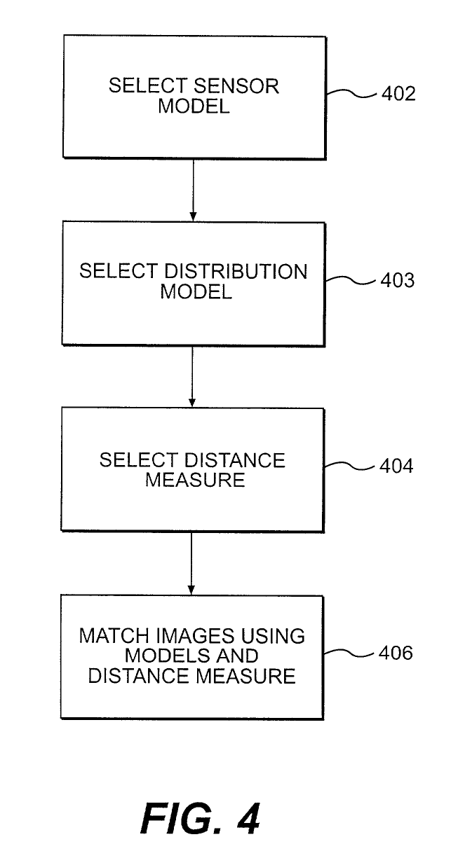

An embodiment of a method consistent with the present invention for registering images without using atlases is shown in FIG. 4. In the method illustrated in FIG. 1, atlas information is registered with a scanned image, wherein the atlas information can be in a data set with a common coordinate system. When multiple images are available, for example, representing anatomical regions of interest, but the information in the images is not registered in a common coordinate system, the method of FIG. 4 is appropriate for creating a composite image fusing the available information from the images. Accordingly, for example, instead of registering atlas images with scanned images, image 200 and 220 in FIGS. 2 and 3 in the method depicted in FIG. 4 are both scanned images.

At step 402, a model for each sensor modality is selected for the images to be registered. In addition, the models selected can reflect the distribution of anatomical elements (“distribution models”), such as tissue of various types and other components that are homogeneous, or essentially of the same type (such as organs, skeletal structure, fluid, etc.) in the images (step 403). One way such models are constructed is by assigning a common label to each image element, e.g., for each voxel (when volume images are used), in the images representing the same structure. Alternatively, the registration method illustrated in FIG. 4 can be executed without using sensor models, using distribution models. Sensor models and distribution models are among the models collectively referred to as “registration models.”

A distance metric (for example as described in greater detail above with respect to the method shown in FIG. 1) is selected to measure the distances between the image models (step 404).

At step 406, the images to be registered are mapped to each other according to the models selected at step 402 using, for example, techniques disclosed in U.S. Pat. No. 6,009,212 and U.S. patent application Ser. No. 09/186,359.

The methods described above have many applications. One example application of an embodiment consistent with the present invention is an image registration technique for flouroscopic positioning. In flouroscopic positioning, images representing a projection of a patient's body are transformed to rigidly position the subject for analysis or surgery. The imaging modalities suitable for this registration technique include three-dimensional atlases, two-dimensional projection data (such as X-ray, CT, ultrasound, or flouroscopy).

An embodiment consistent with the present invention uses CT images of a subject's spinal column containing vertebral bodies. The image is assumed to comprise two tissue types, tissue of the vertebral bodies (“VERT”) and tissue that is not part of the vertebral bodies (“NOTVERT”). Each voxel in the images is labeled as either VERT or NOTVERT. Accordingly, the statistics for a model used for registration can be derived from the distribution of the objects in the images as given by the labeling of the pixels. An example of a statistical model consistent with the present invention representative of the distribution of VERT and NOTVERT is a Gaussian distribution. Accordingly, this model is defined with the estimation of a mean and variance for the distribution. For example, in gray scale imagery, where every voxel has a value in the range of 0 to 255, the mean and variance for the distribution of the areas representing vertebral bodies is computed according to the gray scale of each voxel labeled VERT. Similarly, the mean and variance for the distribution of the areas not representing vertebral bodies is computed according to the gray scale of each voxel labeled NOTVERT.

In accordance with an embodiment of the present invention, CT images I¹ and I² are acquired containing vertebral bodies. Image I¹ is segmented by labeling each voxel as either tissue type VERT or NOTVERT. More than one image can be segmented if desired. The set of segments created by labeling the voxels is denoted A* consisting of the labels at every voxel {a*(x)}. Given this segmentation, a coordinate system transformation using means and variances μ(a), σ(a) for each compartment type α over the entire imagery volume (Ω) is:

$$\begin{matrix}\hat{h} = arg {max}_{h ∈ H} {\int }_{{Ω}^{1}} \frac{{\vert {I}^{1} ( x ) - {μ}_{1} ( a * ( x ) ) \vert}^{2}}{{σ}_{1}^{2} ( a * ( x ) )} + \\ {\int }_{{Ω}^{2}} \frac{{\vert {I}^{2} ( x ) - ( ThA * ( x ) ) \vert}^{2}}{{σ}_{2}^{2}}\end{matrix} \qquad ( 3 )$$

where H is the set of possible rigid transformations. In the above transformation, the image I² is modeled as a Gaussian distribution having a projective transformation:

T:Aε0, 1^{|Ω·|→}IR^{|Ω2|}

Here it is assumed that the distribution I² has uniform variance, but one skilled in the art will recognize that other distributions and statistics are consistent with the present invention. The transformation, h, is computed using a search algorithm, for example, a gradient descent algorithm, over the orthogonal group of rigid body transformations.

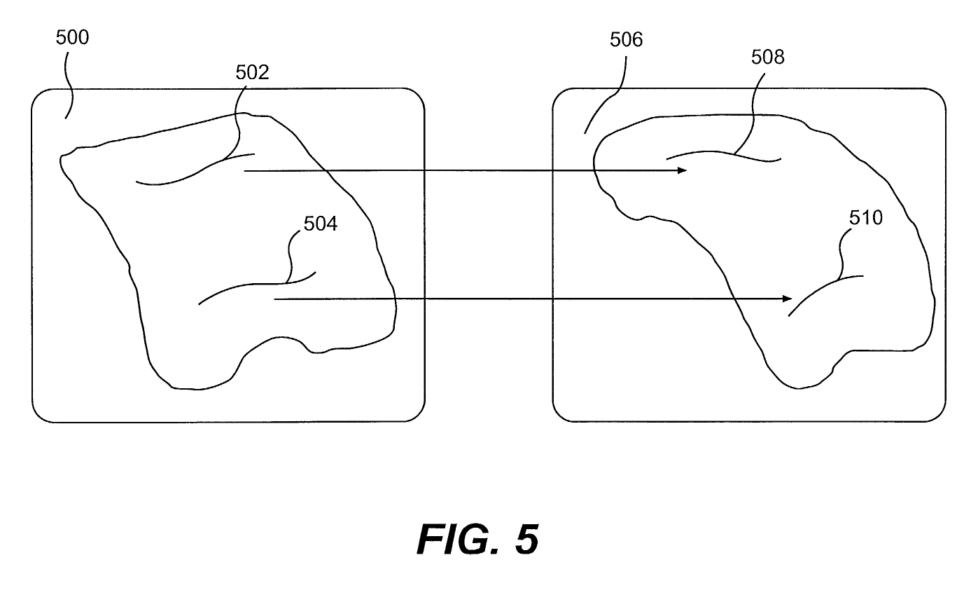

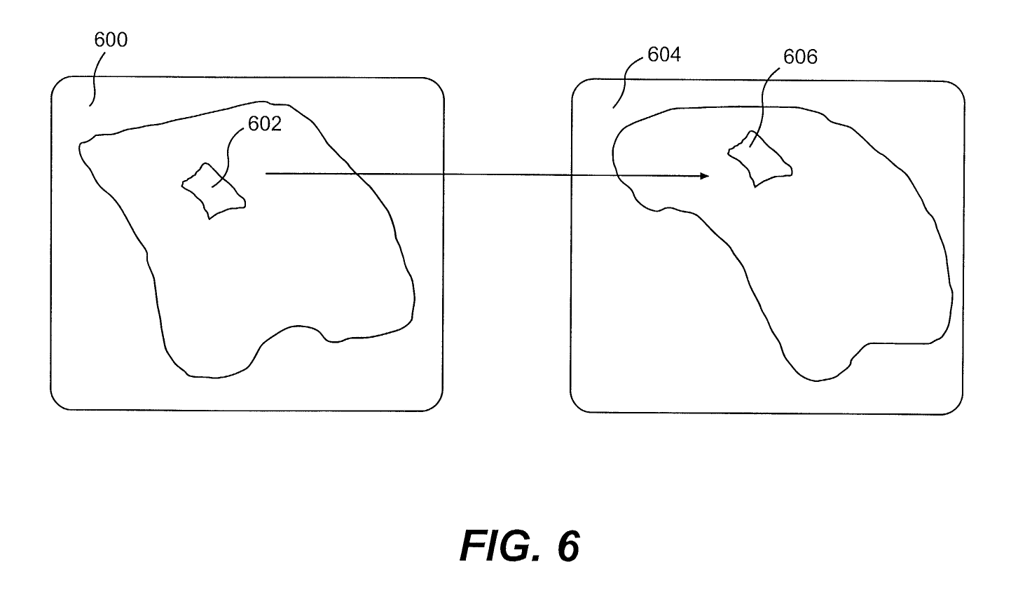

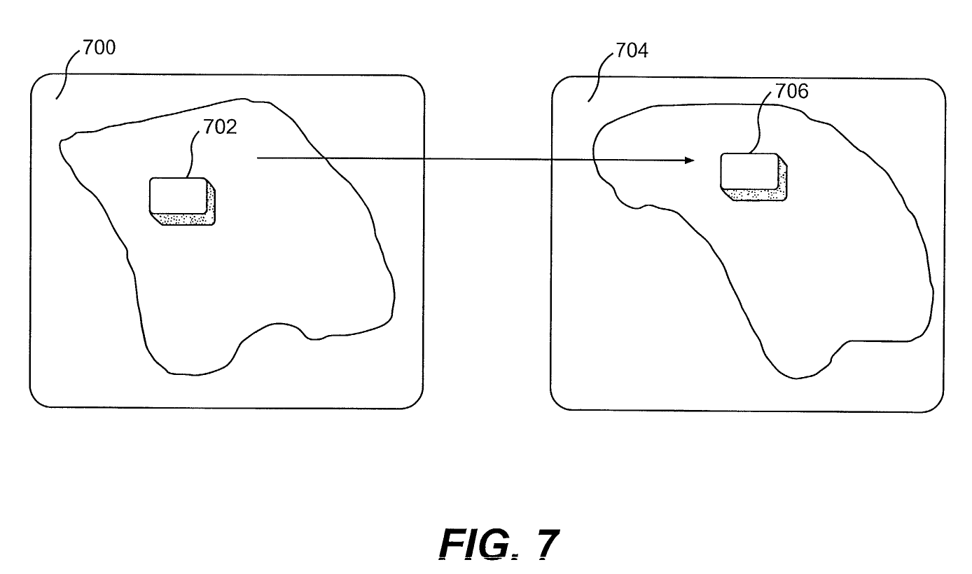

Another embodiment consistent with the present invention, registers landmarks with curves, surfaces, and volumes in images. The registration techniques described herein accommodate landmarks that are individual points (0-dimensional manifolds) as well as manifolds of dimensions 1, 2 and 3 corresponding to curves (1-dimensional), surfaces (2-dimensional) and subvolumes (3-dimensional). For example, FIG. 5 shows an image 500 of a section of a brain with 1-dimensional manifolds 502 and 504 corresponding to image 506 1-dimensional manifolds 508 and 510 respectively. FIG. 6 shows an image 600 of a section of a brain with 2-dimensional manifold 602 corresponding to image 604 2-dimensional manifold 606. FIG. 7 shows an image 700 of a section of a brain with 3-dimensional manifold 702 corresponding to image 704 3-dimensional manifold 706.

This capability is useful, for example, in surgical procedures and facilitates accurate probe placement at precise locations within the body. For spine placement applications, landmarks are points on the vertebral surface. For these applications, CT images are an appropriate modality to provide images of reconstructions of the vertebral body surfaces. Data representing anatomical landmark points defining the coordinate system of an individual are measured. Measurement can be acquired by an operator (such as a surgeon) in a variety of ways, including, for example, using optical, electrical, mechanical, or other suitable probes placed in an operating field or placed on an image display. These measurements are the points yₙ, where n=1, . . . , N. The corresponding features (e.g., lines, surfaces, or volumes) in the images to be registered with the landmarks are expressed as M(x), where x is a position within a feature in an image. The features are assumed to have known statistical properties, for example, the magnitude of the image elements is assumed to adhere to a Gaussian distribution with mean μ and variance σ. The expression for the transform registering landmarks with image features is:

$$\hat{h} = arg {max}_{h} {\sum }_{i = 1}^{N} E ( M ( h ( {y}_{i} ) ) . \qquad ( 4 )$$

Data models for M(yₗ) include Gaussian distributions with means μ(yᵢ), Σ(yₗ), then

$$\begin{matrix}\hat{h} = arg {max}_{h} {\sum }_{i = 1}^{N} {( M ( h ( {y}_{i} ) ) - μ ( h ( {y}_{i} ) ) )}^{{t}_{{\sum }_{6}^{- 1}}} ( M ( h ( {y}_{i} ) ) - \\ μ ( h ( {y}_{i} ) ) ) .\end{matrix} \qquad ( 5 )$$

The measurements are in general vector valued, but can be scalar.

Thus, in accordance with an embodiment of the present invention, the registration apparatus computes the transform h matching the landmarks with the image features of interest.

An embodiment consistent with the present invention matches features in images to an individual's coordinate system using landmarks placed at surfaces of connected regions. In this embodiment, in addition to the measured landmarks, mathematical normals are used to supplement the registration process. The normals are vectors that are normal to the surface reconstructed in the image corresponding to the selected landmarks. The normals define the variation in the image element values at the landmark locations on the surface. Including the normal vectors in the distance measure used in the registration transform can improve registration. The landmark-normal pairs are (yₗ, nᵢ), where i=1, . . . , N. A method for registering images to the individual's coordinate system using these landmarks and corresponding normals consistent with the present invention comprises the following steps:

1. Select landmark points at the boundary of anatomical regions representing connected subvolumes (surfaces) in an individual. When, for example, a surgeon uses a probe to select landmark points, the vector created by the handle of the probe can be used to compute the normals to the surface at the landmark points. As is evident in the equations below, the vectors need not be exact normals to the selected landmark points to provide improved registration accuracy. Alternatively, the normals can be automatically generated using, for example, surface gradient mathematics known in the art.

2. Compute the gradient measurements M(x) of image I(x), the image to be registered with the landmark points selected in the individual.

3. Model the gradient measurements M(x) as a Gaussian distribution with mean vector and covariance μ(x), Σ(x), respectively.

4. Compute the registration transform, h, matching landmarks and their normals with corresponding image elements and their gradient measurements. One skilled in the art will recognize that there are many possible ways of computing h. One solution technique consistent with the present invention uses coarse and fine optimization in parameter spaces corresponding to low and high dimensional transforms, respectively. When a small number of landmark points are selected, the parameters for the transform are determined from an exhaustive search through the parameter space. Expressed mathematically, given a a sequence of parameter sets refining the full space H¹ . . . H, then define the sequence of estimators h¹, h², . . . :

$$\begin{matrix}{\hat{h}}^{i} = arg {max}_{h ∈ {H}^{i}} {\sum }_{y ∈ y} {( M ( h ( y ) ) - μ ( h ( {y}_{i} ) ) )}^{{t}_{\sum }} ( H ( y ) ) ( M ( h ( y ) ) - \\ μ ( h ( y ) ) ) .\end{matrix} \qquad ( 6 )$$

If observations are positions (points) in the imagery rather than normal vectors (for example when vectors of image intensities are not available), then the cost function in the optimization equation for the registration transform h changes to an equation for the distance to the surface from the landmarks. This distance is set to the minimum distance to all points on the surface. Denoting μ(y) as a point on the surface closest to point y, then the cost function is:

$${\hat{h}}^{i} = arg {max}_{h ∈ {H}^{i}} {\sum }_{y ∈ y} \frac{{( ‖ M ( h ( y ) ) - μ ( h ( y ) ) ‖ )}^{2}}{{σ}^{2}} . \qquad ( 7 )$$

Another embodiment consistent with the present invention registers images by matching corresponding elements among the images. One application of this technique is the registration of images acquired of a patient showing several views, perhaps using different imaging modalities, of the same anatomical region of interest. Computing a registration transform to match entire images, or regions within images, following the framework described above, produces a cost function that covers many more points than the landmark alignment technique. Accordingly, the parameters of an image matching registration transform can be computed using efficient pursuit algorithms, such as gradient descent algorithms, because there are many more data points available for the optimization computation.

A method for computing a registration transform for matching images consistent with the present invention comprises the following steps:

1. Select landmark points along the boundary of connected subvolumes shown in a first image. The landmark points locations and corresponding normals are (yᵢnᵢ), i=1, . . . , N with nᵢ the normal direction of surface at point yᵢ.

2. For each image I(x) being registered, at points x within a region of interest, compute the gradient of each image to produce measurement M(x)←∇I(x), with M(x), xεΩ modelled as a Gaussian distribution with mean vector and covariance μ(x), Σ(x), respectively.

3. Define a sequence of data and target smoothed data images M¹, μ¹, M², μ², . . . Mⁿ, μⁿ=M, μ, with

$${M}^{i} ( x ) = {\int }_{Ω} M ( y ) {p}_{σ1} ( x - y ) ⅆ y , \qquad ( 8 )$$

$${μ}^{1} ( x ) = {\sum }_{i = 1}^{n} μ ( {y}_{i} ) p {σ}_{1} ( x - {y}_{i} ) ; \qquad ( 9 )$$

Each Mⁱ, μⁱ pair correspond to an image at a given resolution in the set of N multiresolution images. Where p_{σn}(·) is the probability distribution function serving as a smoothing function for each image, which is δ(·). Other suitable smoothing functions include, for example, Gaussian, Chebychev, Butterworth, and wavelet functions. Then, the image registration transform is computed according to the following image matching cost minimization.

$${\hat{h}}^{i} = arg {min}_{h ∈ H} {\int }_{Ω} {( {M}^{i} ( x ) - {μ}^{i} ( x ) )}^{{t}_{{\sum }^{- 1}}} ( x ) ( {M}^{i} ( x ) - {μ}^{i} ( x ) ) \qquad ( 10 )$$

The vector equation for Σ(x)=σ² reduces to the matching of three modality images simultaneously:

$${\hat{h}}^{i} = arg {min}_{h ∈ H} {\sum }_{j = 1}^{3} {\int }_{Ω} \frac{{( {M}_{j}^{i} ( x ) - {μ}_{j}^{i} ( x ) )}^{2}}{{σ}^{2}} . \qquad ( 11 )$$

This expression is evaluated by computing the gradient flow for a small number of iterations (i−1, 2, . . . , n) for each smoothing or resolution choice.

While the disclosed system and method is useful for medical imaging systems used for noninvasive exploration of human anatomy, for example, flouroscopy, computed tomography, and magnetic resonance imaging, this invention can also be used on images acquired from other imaging modalities. Furthermore, application of the present invention is not limited to anatomical images.

It will be apparent to those skilled in the art that various modifications and variations can be made to the disclosed embodiments of the present invention without departing from the spirit or scope of the invention. Thus it is intended that the present invention cover the modifications and variations of this invention provided they come within the scope of the appended claims and their equivalents.

I claim:

1. An apparatus for image registration comprising:
a controller for selecting at least one reference information structure;
a controller for selecting at least one sensor model; and
a processor for matching image data to said at least one reference information structure using said at least one sensor model.

2. The apparatus of claim 1, wherein at least one of said at least one reference information structure comprises
an anatomical atlas.

3. The apparatus of claim 2, wherein said anatomical atlas comprises
a coordinate system.

4. The apparatus of claim 1, wherein at least one of said at least one sensor model comprises
a model corresponding to a modality of a sensor used to acquire said image data.

5. The apparatus of claim 1, wherein at least one of said at least one sensor model comprises
a model of the distribution of elements representing features in said image data.

6. The apparatus of claim 1, wherein at least one of said at least one sensor model comprises
a model of the distribution of elements representing anatomical features in said image data.

7. An apparatus for image registration comprising:
a controller for selecting at least two images;
a controller for selecting at least one sensor model;
a controller for selecting at least one distribution model; and
a processor for matching said at least two images to each other using said sensor model and said at least one distribution model.

8. The apparatus of claim 7, further comprising:
a controller for selecting at least one landmark in at least one of the selected images, and
wherein said processor further comprises means for matching said selected images using said selected at least one landmark.

9. The apparatus of claim 7, wherein at least one of said at least one sensor model comprises
a model corresponding to a modality of a sensor used to acquire image data to be registered.

10. The apparatus of claim 7, wherein at least one of said at least one distribution model comprises:
a model of the distribution of elements representing anatomical features.

11. An apparatus for image registration comprising:
a controller for selecting at least a first image and a second image;
a controller for selecting at least one distribution model corresponding to a segmentation of said first image; and
a processor for matching at least said first image and said second image using said at least one distribution model.

12. The apparatus of claim 11, wherein the distribution model further comprises
a representation of the distribution of elements in an image comprising at least one feature of interest.

13. An apparatus for image registration comprising:
a controller for selecting at least a first image and a second image;
a controller for selecting at least two distribution models;
a controller for selecting a distance measure for measuring a distance between at least two of said selected distribution models; and
a processor for matching at least said first image and said second image using said at least one distribution model and said distance measure.

14. A method for image registration comprising:
selecting a registration model;
selecting a distance measure incorporating the registration model; and
registering a first image with at least a second image using a registration transform using said distance measure.

15. The method of claim 14, wherein the step of selecting a registration model comprises the step of:
selecting a registration model corresponding to a sensor modality.

16. The method of claim 14, wherein the step of selecting a registration model comprises the step of:
selecting a registration model corresponding to a distribution of image elements constituting an image feature.

17. A method for image registration comprising:
selecting at least one landmark in a first image;
determining at least one normal vector for at least one of said selected at least one landmark;
computing at least one gradient vector for a second image; and
registering said first image and said second image by matching said at least one normal vector corresponding to said first image to said at least one gradient vector for said second image.

18. A method for image registration comprising:
selecting at least one reference information structure;
selecting at least one sensor model; and
matching image data to said at least one reference information structure using said at least one sensor model.

19. A method for image registration comprising:
selecting at least two images;
selecting at least one sensor model;
selecting at least one distribution model; and
matching said at least two images to each other using said at least one sensor model and said at least one distribution model.

20. A method for image registration comprising:
selecting at least a first image and a second image;
selecting at least one distribution model corresponding to a segmentation of said first image; and
matching at least said first image and said second image using said at least one distribution model.

21. An apparatus for image registration comprising:
means for selecting a registration model;
means for selecting a distance measure incorporating the registration model; and
means for registering a first image with at least a second image using a registration transform using said distance measure.

22. An apparatus for image registration comprising:
means for selecting at least one landmark in a first image;
means for determining at least one normal vector for at least one of said selected at least one landmark;
means for computing at least one gradient vector for a second image; and
means for registering said first image and said second image by matching said at least one normal vector corresponding to said first image to said at least one gradient vector for said second image.

23. An apparatus for image registration comprising:
means for selecting at least one reference information structure;
means for selecting at least one sensor model; and
means for matching image data to said at least one reference information structure using said at least one sensor model.

24. An apparatus for image registration comprising:
means for selecting a first image and a second image;
means for selecting at least one sensor model;
means for selecting at least one distribution model; and
means for matching said first image and said second image using said sensor model and said at least one distribution model.

25. An apparatus for image registration comprising:
means for selecting at least a first image and a second image;
means for selecting at least one distribution model corresponding to a segmentation of said first image; and
means for matching at least said first image and said second image using said at least one distribution model.

26. A method for image registration during a medical procedure comprising:
selecting landmarks on a subject's body with a probe;
computing from an orientation of said probe, corresponding normals for said selected landmarks;
computing normals for an image, wherein said image contains elements corresponding to said selected landmarks on said subject's body; and
registering said image with a coordinate frame corresponding to a position of said subject's body by relating said normals for said selected landmarks to said normals for said image.

27. An apparatus for image registration during a medical procedure comprising:
a probe;
means for computing from an orientation of said probe, normals corresponding to landmarks on a subject's body selected by said probe;
means for computing normals for an image, wherein said image contains elements corresponding to said selected landmarks on said subject's body; and
means for registering said image with a coordinate frame corresponding to a position of said subject's body by relating said normals for said selected landmarks to said normals for said image.

28. A surgical navigation system comprising:
a probe;
means for computing from an orientation of said probe, normals corresponding to landmarks on a subject's body selected by said probe;
means for computing normals for an image, wherein said image contains elements corresponding to said selected landmarks on said subject's body; and
means for registering said image with a coordinate frame corresponding to a position of said subject's body by relating said normals for said selected landmarks to said normals for said image.

29. A surgical navigation system for image registration comprising:
a controller for selecting at least one reference information structure;
a controller for selecting at least one sensor model; and
a processor for matching image data to said at least one reference information structure using said at least one sensor model.

30. A surgical navigation system for image registration comprising:
a controller for selecting at least a first image and a second image;
a controller for selecting at least one distribution model corresponding to a segmentation of said first image; and
a processor for matching at least said first image and said second image using said at least one distribution model.

31. A surgical navigation system for image registration comprising:
selecting a registration model;
selecting a distance measure incorporating the registration model; and
registering a first image with at least a second image using a registration transform using said distance measure.

32. An apparatus for image registration comprising:
means for selecting a registration model;
means for selecting a distance measure incorporating the registration model; and
means for registering a first image with at least a second image using a registration transform using said distance measure.

33. A computer program product for use in a computer adapted for image registration, the computer program product comprising a computer readable medium for storing computer readable code means, which when executed by the computer, enables the computer to perform image registration, and wherein the computer readable code means includes computer readable instructions for causing the computer to execute a method comprising:
means for selecting a registration model;
selecting a registration model;
selecting a distance measure incorporating the registration model; and
registering a first image with at least a second image using a registration transform using said distance measure.

34. A method for correlating images comprising:
selecting a registration model;
selecting a distance measure incorporating the registration model; and
correlating a first image with at least a second image using a transform using said distance measure.

35. A method for correlating images comprising:
selecting a gaussian registration model comprising at least one of either a sensor model or a distribution model indicating the distribution of image elements constituting at least one anatomic feature of interest;
selecting a Kullback-Liebler distance measure incorporating the registration model; and
correlating a first image with at least a second image using a transform using said distance measure.
